(19) United States
(12) Patent Application Publication
(10) Pub. No.: US 2025/0328305 A1
(43) Pub. Date: Oct. 23, 2025

(54) METHOD FOR PROVIDING SCREEN SHARING DURING CALL AND ELECTRONIC DEVICE SUPPORTING SAME

(71) Applicant: KAKAO CORP., Jeju-si (KR)

(72) Inventors: Eun Hye EE, Seongnam-si (KR); Bon Hyeok KOO, Seongnam-si (KR)

(21) Appl. No.: 19/089,540

(22) Filed: Mar. 25, 2025

(30) Foreign Application Priority Data
Apr. 22, 2024 (KR) 10-2024-0053195

(51) Int. Cl. G06F 3/14; G06F 3/04842; H04L 9/40; H04L 65/1069

(52) U.S. Cl. CPC G06F 3/1454; H04L 63/04; H04L 65/1069; G06F 3/04842

(57) ABSTRACT

Proposed is a method for providing screen sharing during a call and an electronic device supporting the same. A terminal may establish a call with at least one other terminal through an application, receive an interaction requesting screen sharing with at least one other terminal, de-identify information related to the application, and initiate screen sharing with at least one other terminal

### CROSS-REFERENCE TO RELATED APPLICATION

This application claims priority to and the benefit of Korean Patent Application No. 10-2024-0053195 filed on Apr. 22, 2024, the disclosure of which is incorporated herein by reference in its entirety.

### BACKGROUND

### Technical Field

The present disclosure relates to a method for providing screen sharing during a call between terminals and an electronic device supporting the same.

### Description of Related Technology

Applications are software that can send and receive messages or data in real time between different terminals, facilitating communication between the terminals. The applications are becoming more widespread and accessible in mobile environments. Additionally, with the growing popularity of applications, a wider range of features is being provided. For example, there are applications supporting video conferencing, webinars, real-time team collaboration, and remote sharing.

### SUMMARY

The present disclosure provides a method for limiting certain information included in a shared screen, and an electronic device supporting the same, in order to protect personal information of terminal users and minimize information exposure when sharing a screen during a call between terminals.

In one aspect, there is provided a method for providing screen sharing by a terminal during a call, and the method includes: establishing a call with at least one other terminal through an application; receiving an interaction requesting screen sharing with the at least one other terminal; de-identifying information related to the application; and initiating screen sharing with the at least one other terminal.

The information related to the application may include at least one of chat room information on the application and account information on the terminal.

The de-identifying of the information related to the application may include blurring at least one of the chat room information on the application and the account information on the terminal to prevent sharing with the at least one other terminal.

The de-identifying of the information related to the application may include changing at least one of the chat room information on the application and the account information on the terminal.

The method may further include deactivating a camera module of the terminal in response to receiving an interaction requesting screen sharing with the at least one other terminal.

The method may further include further comprising The de-identifying of the account information on the at least one other terminal that has established the call.

The method may further include, in response to an interaction requesting screen sharing with the at least one other terminal, de-identifying at least one icon among a status icon, a notification display information icon, and a control icon of the terminal.

The de-identifying of the information related to the application may include: when screen sharing with the at least one other terminal is initiated, displaying on a screen of the terminal a screen sharing interface that supports execution of the screen sharing; and in response to an interaction with an de-identification interface included in the screen sharing interface, de-identifying at least one of the chat room information on the application and the account information on the terminal to prevent sharing with the at least one other terminal.

The method may further include: receiving a selection interaction with an application for screen sharing with the at least one other terminal; and determining whether the application that has received the selection interaction is a preset screen sharing-restricted application.

The method may further include: receiving a selection interaction with an application for screen sharing with the at least one other terminal; initiating screen sharing of an application that has received the selection interaction, with at least one other terminal; and when the application is in a background state due to the interaction of the terminal, terminating the initiated screen sharing.

In another aspect, there is provided a terminal providing screen sharing during a call, and the terminal includes a memory storing instructions, and a processor configured to execute the instructions to: establish a call with at least one other terminal through an application; receive an interaction requesting screen sharing with the at least one other terminal; de-identify information related to the application; and initiate screen sharing with the at least one other terminal.

In yet another aspect, there is provided a method for providing screen sharing by a server during a call, and the method includes: establishing a call between a terminal and at least one other terminal through an application; receiving a screen sharing request from the terminal to share a screen with the at least one other terminal; de-identifying information related to the application; and providing screen sharing to the terminal and the at least one other terminal.

The information related to the application may include at least one of chat room information on the application and account information on the terminal.

The de-identifying of the information related to the application may include blurring at least one of chat room information on the application and account information on the terminal to prevent sharing between the terminal and the at least one other terminal.

The de-identifying of the information related to the application may include changing at least one of the chat room information on the application and the account information on the terminal.

The method may further include The de-identifying of the account information on the at least one other terminal having established the call with the terminal.

The de-identifying of the account information on the at least one other terminal having established the call with the terminal may include comprises changing the account information on the at least one other terminal.

The de-identifying of the information related to the application may include: receiving an interaction of the terminal with a screen sharing interface that supports execution of screen sharing of the terminal; and de-identifying at least one of the chat room information on the application and the account information on the terminal so that the blurred information is not shared between the terminal and the at least one other terminal.

In yet another aspect, there is provided a server providing screen sharing during a call, and the server includes a memory storing instructions, and a processor configured to execute the instructions to: establish a call between a terminal and at least one other terminal through an application; receive a screen sharing request from the terminal to share a screen with the at least one other terminal; de-identify information related to the application; and provide screen sharing to the terminal and the at least one other terminal.

In yet another aspect, there is provided a non-transitory computer readable recording medium storing instructions, when executed by one or more processors, configured to perform at ;east one of the above-described methods.

### BRIEF DESCRIPTION OF THE DRAWINGS

FIG. 1 is a diagram illustrating an example of a network environment according to one embodiment of the present disclosure.

FIG. 2 is a diagram illustrating an example in which a terminal initiates sharing of a screen with certain information restricted, according to one embodiment of the present disclosure.

FIG. 3 is a diagram illustrating an example of a terminal requesting screen sharing during a voice call according to one embodiment of the present disclosure.

FIGS. 4A to 4D are diagrams illustrating an example in which a terminal shares a screen with certain information restricted during a voice call.

FIG. 5 is a diagram illustrating an example of a terminal requesting screen sharing during a video call according to one embodiment of the present disclosure.

FIGS. 6A to 6D are diagrams illustrating an example of a terminal sharing a screen with certain information restricted during a video call.

FIG. 7A and FIG. 7B are diagrams illustrating an example in which a terminal selects a screen sharing-restricted application.

FIG. 8 is a diagram illustrating an example in which a server provides screen sharing between a terminal and at least one other terminal, with restricted sharing of certain information.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. These terms are generally only used to distinguish one element from another.

As used herein, the singular forms “a”, “an,” and “the” are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

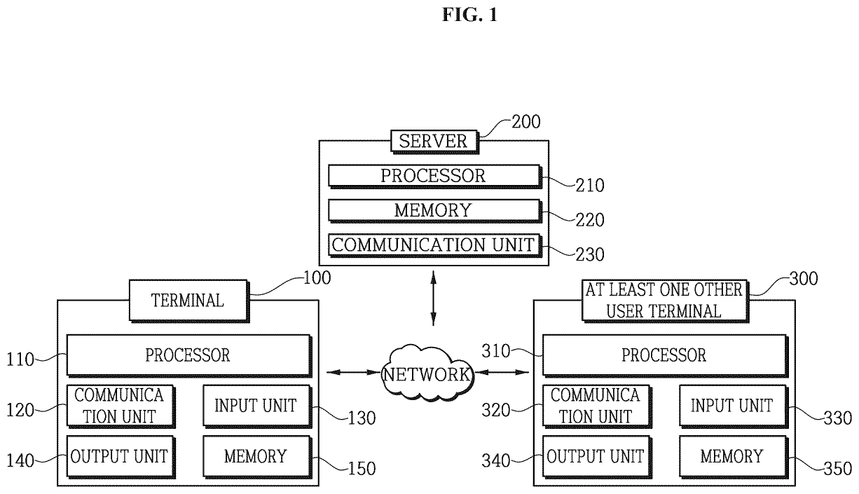

FIG. 1 is a diagram illustrating an example of a network environment according to one embodiment of the present disclosure.

Hereinafter, the present disclosure will be described with reference to the attached drawings.

According to various embodiments, a terminal 100 may be connected to a server 200 and at least one other terminal 300 over a network. Here, at least one other terminal 300 may refer to one or more external terminals other than the terminal 100. For example, at least one other terminal 300 may be a second terminal, a third terminal, and/or a fourth terminal other than the terminal 100. Communication schemes for a network is not limited. The communication schemes may include not only a communication scheme to utilize a telecommunication network (for example, a mobile communication network, wired Internet, wireless Internet, and a broadcast network), but also a short-range radio communication scheme.

According to various embodiments, the terminal 100 may, for example, include at least one of a smartphone, a tablet personal computer, a mobile phone, a video phone, an e-book reader, a desktop personal computer, a laptop personal computer, a netbook computer, a workstation, a server, a personal digital assistant (PDA), a portable multimedia player (PMP), an MP3 player, a mobile medical device, a camera, or a wearable device.

Referring to FIG. 1, according to various embodiments, the terminal 100 may include a processor 110, a communication unit 120, an input unit 130, an output unit 140, and a memory 150. According to one embodiment, at least one of the aforementioned elements of the terminal 100 may be omitted or any other elements may be additionally provided.

The processor 110 may drive an operating system or application program to control a number of hardware or software elements connected to the processor 110 and perform various data processing and operations. The processor 110 may execute an application by controlling the overall operation of the communication unit 120, the input unit 130, the output unit 140, and the memory 150.

According to various embodiments, the processor 110 may establish a call with at least one other terminal 300 through an application. Here, the application may be an Internet space that provides communication or information exchange features between terminal users to share interests or hobbies using the terminal 100 or at least one other terminal 300. According to one embodiment, the application may be an application that provides at least one of a chat feature, a voice call feature, and a video call feature. For example, the application may provide a chat feature, a voice call feature, a video call feature, etc. between one user account on the terminal 100 with the application downloaded from the server 200 or external server and another user account.

According to various embodiments, the account on the terminal 100 may be registered as a member of an application (e.g., an application providing a call feature and the like). Here, the application may provide a chat feature, a voice call feature, a video call feature, etc. between terminals (e.g., between the terminal 100 and at least one other terminal 300) that have downloaded or registered as members of the application. The terminal 100 may request call initiation to the server 200 in response to an interaction requesting call initiation to at least one other terminal 300 through a chat room of the application. Here, establishing a call between the terminal 100 and at least one other terminal 300 and/or a plurality of other terminals may be supported through a voice communication technology via Internet Protocol (i.e., Voice over Internet Protocol (VoIP)), a Session Initiation Protocol (SIP), a Real-time Transport Protocol (RTP), a codec conversion technology, a security protocol technology, etc.

According to various embodiments, the processor 110 may receive an interaction that requests screen sharing with at least one other terminal 300. For example, a selection interaction of the terminal 100 requesting screen sharing for various applications (e.g., messenger applications, game applications, stock applications, etc.) stored in the terminal 100, other applications (e.g., search web browser, shopping web browser, etc.) linked through link information (e.g., URL information, hyperlink information, etc.), and the like may be received. Here, the interaction may include touching on a touchscreen, clicking with a mouse, typing on a keyboard, providing voice input through a microphone, capturing an image using a camera, recognizing movements through a motion sensor, and the like.

According to various embodiments, the processor 110 may de-identify information related to the application. For example, the processor 110 may de-identify at least one of chat room information on the application and the account information on the terminal 100. Here, the application chat room information may include a name of a corresponding chat room, a description of the chat room, and link information for accessing the chat room. The account information on the terminal 100 may include profile image information, user chat name information, status message information, etc. of a user of the terminal 100. For example, the terminal 100 may blur the application's chat room name information, the user's profile image information, and the user's chat name information, to prevent sharing with at least one other terminal 300. Here, the terminal 100 blurring information may mean a technology or process of blurring a specific part of digital content (e.g., image information).

In one embodiment, when the processor 110 receives an interaction requesting screen sharing with at least one other terminal 300, the information related to the application may be de-identified in real time without additional interaction performed by the user of the terminal 100. For example, the processor 110 may de-identify at least one of the chat room information on the application and the account information on the terminal 100 in real time without additional interaction performed by the user of the terminal 100.

According to yet another embodiment, when the processor 110 receives an interaction requesting screen sharing with at least one other terminal 300, the processor 110 may identify the interaction of the terminal 100 selecting whether to de-identify at least one of the chat room information on the application and the account information on the terminal 100 in real time. The processor 110 may determine whether to de-identify at least one of the chat room information on the application and the account information on the terminal 100 based on the selection interaction of the terminal 100.

According to various embodiments, the processor 110 may initiate screen sharing with at least one other terminal 300. The screen sharing may allow sharing only a screen where at least one of the deidentified chat room information on the application or the de-identified account information on the terminal 100 is excluded.

According to one embodiment, in response to a selection interaction of the terminal 100 with an application for screen sharing (e.g., a messenger application, a calculator application, a game application, etc.), the processor 110 may initiate screen sharing of the application that has received the selection interaction, with at least one other terminal 300.

The communication unit 120 may establish communication between the terminal 100 and an external electronic device. For example, the communication unit 120 may be connected to a network through wireless communication or wired communication to communicate with an external electronic device (e.g., an external server) or a server 200.

The input unit 130 may serve as an interface capable of transmitting commands or data input from a user or another external device to other element(s) of the terminal 100. Additionally, the input unit 130 may output commands or data received from other element(s) of the terminal 100 to the user or other external devices. For example, the input unit 130 may be a touch screen module, a keyboard, a mouse, a button, a camera, a stylus, a microphone, etc.

The terminal 100 may receive a user's interaction through the input unit 130. The interaction refers to a process where the user manipulates the input unit 130 to input information reflecting his or her choices or intentions into the terminal 100.

The output unit 140 may output various information. The output unit 140 may be a display, a touch screen, a speaker, a vibration-generating device, a tactile-generating device, etc. The output unit 140 may, for example, display various contents (e.g., texts, images, videos, icons, or symbols) to the user. According to various embodiments, the output unit 140 may be a device (e.g., Bluetooth earphone) connected to the terminal 100 through wired or wireless communication (e.g., short-range wireless communication such as Bluetooth) to receive and output signals.

The memory 150 may serve as a storage medium and may store a number of application programs running on the terminal 100, and data commands for the operation of the terminal 100. This memory 150 may be provided in the form of hardware, various storage devices such as ROM, RAM, flash drives, hard drives, or may be provided in the form of web storage. In one embodiment, an application related to a messenger service (hereinafter, referred to as an “application”) may be stored in the memory 150.

According to various embodiments of the present disclosure, the server 200 may be implemented as a single computer device or a plurality of computer devices that provide commands, codes, files, contents, services, etc. The server 200 may be a server capable of transmitting and receiving information through communication with the terminal 100 over a network.

According to various embodiments, the server 200 may be a device that provides an application to the terminal 100. The terminal 100 may be a device that uses the application provided by the server 200. The application may be a messenger application, which provides a service that allows a plurality of users to send or receive messages to each other through a platform provided by the server 200. Here, a message may encompass all transmittable data, including text, photos, videos, voice files, and emoticons.

According to various embodiments, the server 200 may be connected to the terminal 100 and at least one other terminal 300 over a network. Communication schemes for a network is not limited. The communication schemes may include not only a communication scheme to utilize a telecommunication network (for example, a mobile communication network, wired Internet, wireless Internet, and a broadcast network), but also a short-range radio communication scheme.

The server 200 according to various embodiments of the present disclosure may be implemented as a single computer device or a plurality of computer devices that provide commands, codes, files, content, services, etc. The server 200 according to one embodiment may be an electronic device capable of transmitting and receiving information through communication with a terminal 100 and at least one other terminal 300 over a network. For convenience of explanation, the server 200 has been described as a single server, but the server 200 may be composed of a plurality of servers that provide different functions or services.

According to various embodiments, when the terminal 100 or at least one other terminal 300 are to perform a predetermined function or service automatically or upon a request, the terminal 100 and at least one other terminal 300 may request the server 200 to perform at least some functions related the predetermined function, instead of or in addition to executing the predetermined function or service on its own. The server 200 may execute a requested function or additional function and transmit a result to the terminal 100 and at least one other terminal 300. The terminal 100 and at least one other terminal 300 may process the received result as is or additionally to provide the requested function or service. For example, cloud computing, distributed computing, or client-server computing technologies may be utilized.

The server 200 may include a processor 210, a memory 220, and a communication unit 230. The processor 210 may control the overall operation of the memory 220 and the communication unit 230. According to various embodiments of the present disclosure, the memory 220 may serve as a storage medium and may store a plurality of application programs running on the server 200, and data and commands for the operation of the server 200. In one embodiment, the memory 220 may be provided in the form of various storage devices such as hardware, ROM, RAM, flash drive, hard drive, etc., or may be provided in the form of web storage. The communication unit 230 may communicate with the terminal 100 over a network in a wired or wireless manner.

According to various embodiments, the server 200 may provide various applications to the terminal 100. According to one embodiment, in order for the terminal 100, at least one other terminal 300, or an external terminal to download various applications that provide chat features, voice call features, video call features, etc., an external device (e.g., the server 200, an external server linked to the server 200, a third-party server, etc.) may provide related features or interfaces. For example, the applications may include a preloaded application or a third party application downloadable from the server 200.

According to various embodiments, the processor 210 may receive a call request from the terminal 100 for a call with at least one other terminal 300. The processor 210 may establish a call between the terminal 100 and at least one other terminal 300 if at least one other terminal 300 approves the call request.

According to various embodiments, the processor 210 may receive a screen sharing request from the terminal 100 to share a screen with at least one other terminal 300. For example, the processor 210 may receive a screen sharing request for sharing a screen of an application (e.g., a messenger application, an SNS application, etc.) selected by the terminal 100.

The processor 210 may de-identify information related to the application. For example, the processor 210 may de-identify at least one of chat room information on the application and account information on at least one other terminal 300 that has established a call connection with the terminal 100. Here, de-identifying information may refer to blurring the information so that the terminal 100 and at least one other terminal 300 cannot identify the information, or changing the information to random information.

According to one embodiment, when receiving a screen sharing request from the terminal 100, the processor 210 may automatically de-identify at least one of the chat room information on the application (e.g., chat room name, chat room status, etc.) and the account information on at least one other terminal 300 which has established a call connection with the terminal 100. According to yet another embodiment, the processor 210 may determine whether a device requesting screen sharing (e.g., the terminal 100, at least one other terminal 300, etc.) has set whether to de-identify the chat room information on the application and/or the account information on the device. The processor 210 may determine whether to de-identify the chat room information on the application and/or the account information on the device, based on de-identification related setting of the device.

According to various embodiments, the processor 210 may provide screen sharing between the terminal 100 and at least one other terminal 300. According to one embodiment, the processor 210 may provide a screen of an application selected by the terminal 100 to at least one other terminal 300 that has established a call with the terminal 100. For example, during screen sharing, the processor 210 may blur de-identified chat room information on an application and de-identified account information (e.g., user profile image information, user chat name information, etc.) on at least one other terminal 300 that has established a call with the terminal 100, or may change the corresponding information to random information.

At least one other terminal 300 may include a processor 310, a communication unit 320, an input unit 330, an output unit 340, and a memory 350. Here, at least one other terminal 300 refers to one or more devices, but for the convenience of explaining the present disclosure, at least one other terminal 300 will be described as a single device. At least one other terminal 300 refers to a device other than the terminal 100, and each of the processor 310, the communication unit 320, the input unit 330, the output unit 340, and the memory 350 performs or substantially corresponds to at least some functions performed by the processor 110, the communication unit 120, the input unit 130, the output unit 140, and the memory 150, so a detailed description thereof will be omitted. For example, at least one other terminal 300 may establish a call with the terminal 100 through the application. At least one other terminal 300 may download the application from the server 200 or another server linked to the server 200. Additionally, at least one other terminal 300 may share images, videos, data, etc. with the terminal 100 through the application.

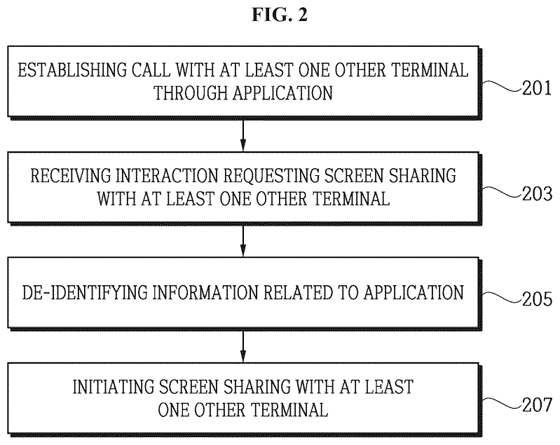

FIG. 2 is a diagram illustrating an example in which a terminal 100 initiates screen sharing in which sharing of certain information is restricted, according to one embodiment of the present disclosure.

In operation 201, the terminal 100 may establish a call with at least one other terminal 300 through an application. The terminal 100 may establish a one-on-one call or group call with at least one other terminal 300 through an application that provides a call feature. Here, if the terminal 100 has established a call with at least one other terminal 300, it may mean that the terminal 100 has successfully established a call with at least one other terminal 300, so that voice, video, data, etc. can be exchanged between the terminal 100 and at least one other terminal 300.

In operation 203, the terminal 100 may receive an interaction requesting screen sharing with at least one other terminal 300. According to various embodiments, the terminal 100 may receive an interaction with a screen sharing interface provided by the application. Here, the application may support a feature for sharing a screen selected by the terminal 100 during the call established between the terminal 100 and at least one other terminal 300.

In operation 205, the terminal 100 may de-identify information related to the application. For example, the terminal 100 may de-identify at least one of chat room information on the application and account information on the terminal 100.

Here, the chat room information on the application may include a chat room's name, the chat room's status, the chat room's link information, etc. For example, the chat room's name may be a name given when the chat room is created or a name given by the terminal 100. The chat room's status may include content describing the purpose or nature of the chat room. The chat room's link information may be an identifier or a web link that allows access to the chat room. Here, the account information on the terminal 100 may be profile information, chat name information, status message information, etc. of a user of the terminal 100. The profile information of the user of the terminal 100 may include image information, interest information, etc. of the user of the terminal 100. The chat name information of the user of the terminal 100 may be a nickname selected by the user of the terminal 100 within the chat room of the application. The status message information of the user of the terminal 100 may be message information (e.g., mood message, status message, etc.) entered by the user of the terminal 100.

According to various embodiments, the terminal 100 may blur at least one of the chat room information on the application and the account information on the terminal 100 to prevent sharing with at least one other terminal 300 that has established a call with the terminal. For example, the terminal 100 may blur the chat room's name, which is the chat room information on the application, and the user profile information, which is the account information on the terminal 100. Here, blurring information may refer to a process of blurring text information or image information so that content included in the information cannot be identified.

According to one embodiment, when receiving an interaction requesting screen sharing with at least one other terminal 300, the terminal 100 may automatically blur at least one of the chat room information on the application and the account information on the terminal 100. According to yet another embodiment, when the terminal 100 receives an interaction requesting screen sharing with at least one other terminal 300, the terminal 100 may check a setting on whether to de-identify the chat room information on the application and the account information on the terminal 100. For example, if the terminal 100 confirms a setting that de-identification is selected only for the chat room information on the application, only the chat room information on the application may be blurred during screen sharing with at least one other terminal 300. As another additional example, if the terminal 100 confirms a setting that de-identification is selected only for the account information on the terminal 100, only the account information on the terminal 100 may be blurred during screen sharing with at least one other terminal 300.

According to various embodiments, when the terminal 100 receives an interaction requesting screen sharing with at least one other terminal 300, the terminal 100 may change at least one of the chat room information on the application and the account information on the terminal 100. By changing at least one of the chat room information on the application and the account information on the terminal 100 to random information, the terminal 100 may not share the corresponding information with at least one other terminal 300 that has established a call with the terminal 100.

For example, the chat room information on the application is the original name of a chat room, which is given when the chat room is created, (e.g., Alumni Club, Professional Club, etc.), and the terminal 100 may change the original name to a random name (e.g., Exciting Chat Group, Fun Chat Group, etc.). Here, the random name may be a random combination of texts, emoticons, etc. As an additional example, the account information on the terminal 100 may be the chat name information for the terminal 100 (e.g., Kevin Kim, Susan Lee, etc.), and the original chat name information may be changed to random account information (e.g., Shy Muzi, Exciting Sky, etc.). Here, the random name may be a random combination of texts, emoticons, etc.

According to various embodiments, the terminal 100 may de-identify account information on at least one other terminal 300 with which a call has been established. According to one embodiment, when the terminal 100 receives an interaction requesting screen sharing with at least one other terminal 300, the terminal 100 may de-identify account information (e.g., user profile information, chat name information, status message information, etc.) of at least one other terminal 300 that has established a call. For example, user profile information of at least one other terminal 300 having established a call with the terminal 100 may be blurred, so that the user profile information cannot be identified. As another example, the terminal 100 may change the user profile information of at least one other terminal 300 having established a call with the terminal 100 to random user profile information, so that the user profile information cannot be identified.

According to various embodiments, when the terminal 100 receives an interaction requesting screen sharing with at least one other terminal 300, the terminal 100 may de-identify at least one of a terminal status icon, a notification display information icon, and a control icon. For example, a screen of the terminal 100 may be composed of a status icon (e.g., battery status information, Wi-Fi connection status, network signal status information, etc.), notification display information icon, control icon (e.g., home soft key, back soft key, recent app soft key, etc.), and the like of the terminal 100. In the above example, when the terminal 100 receives an interaction requesting screen sharing with at least one other terminal 300, the terminal 100 may blur at least one icon of the terminal status icon, the notification display information icon, and the control icon.

In operation 207, the terminal 100 may initiate screen sharing with at least one other terminal 300.

According to various embodiments, the terminal 100 may receive a selection interaction with an application for screen sharing with at least one other terminal 300. For example, the terminal 100 may receive a selection interaction with an application stored in the terminal 100 or with an external application through link information, or the like. The terminal 100 may share a screen of the application, which has received the selection interaction, with at least one other terminal 300. Screen sharing may refer to sharing a screen of at least one application selected by the terminal 100 between the terminal 100 and at least one other terminal 300 in real time.

According to various embodiments, the terminal 100 may determine whether an application selected for screen sharing is a preset screen sharing-restricted application. For example, the terminal 100 or server 200 may set applications such as banking applications, stock trading applications, copyright-protected applications, and test evaluation applications as applications in which sharing with other terminals is not allowed. In the above example, if the application selected for screen sharing is a preset screen sharing-restricted application, the terminal 100 may restrict screen sharing with other terminals. Additionally, the terminal 100 may display, on a screen of the terminal 100, a pop-up message indicating a screen sharing-restricted application.

According to various embodiments, the terminal 100 may deactivate a camera module of an input unit 130 upon receiving an interaction requesting screen sharing with at least one other terminal 300. As a result of deactivating the camera module, the terminal 100 may not share the face of the user of the terminal 100, captured by the camera module, with at least one other terminal 300.

According to various embodiments, when screen sharing with at least one other terminal 300 is initiated, the terminal 100 may display a screen sharing interface, which supports execution of screen sharing, on the screen of the terminal 100. Here, the screen sharing interface may include a volume control icon for screen sharing, a screen sharing stop icon, a join request icon, etc. Here, the volume control icon for screen sharing may be an icon for adjusting the volume of voice during screen sharing. The screen sharing stop icon may be an icon that stops sharing a screen that is currently being shared. The join request icon may be a notification icon indicating a screen sharing request from among all accounts on devices participating in a call. In one embodiment, the screen sharing interface may be displayed only to the terminal 100 that has initiated screen sharing, and may not be displayed to at least one other terminal 300 that has established a call with the terminal 100.

In one embodiment, the screen sharing interface may include an de-identification icon. In the above embodiment, in response to an interaction with the de-identification icon included in the screen sharing interface, the terminal 100 may blur at least one of the chat room information on the application and the account information on the terminal 100 to prevent sharing with at least one other terminal 300 that has established a call connection with the terminal 100. As yet another example, in response to an interaction with the de-identification icon included in the screen sharing interface, the terminal 100 may change at least one of the chat room information on the application and the account information on the terminal 100 to random information.

According to various embodiments, after the terminal 100 initiates screen sharing of an application with at least one terminal, the terminal 100 may receive an interaction changing the application to a background state. For example, if the terminal 100 receives an interaction with a home button, a lock button, a back button, or the like during screen sharing, the terminal 100 may change the application to the background state. Here, the background state of the application, which is distinct from a foreground state of the application, may refer to a state in which the application is not displayed on the screen of the terminal 100 but is activated and continues to use system resources of the terminal 100.

According to various embodiments, when the application is changed to the background state during screen sharing for the application, the terminal 100 may terminate screen sharing for the application.

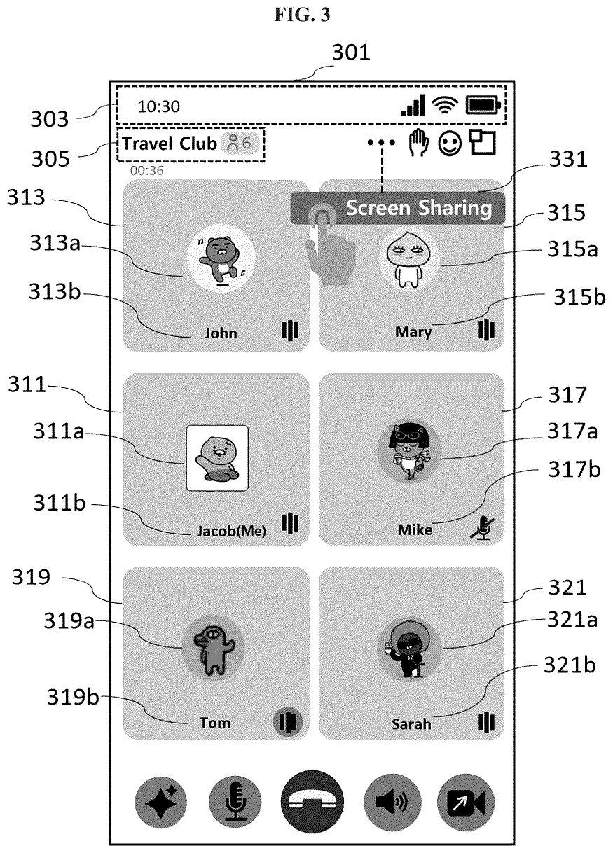

FIG. 3 is a drawing illustrating an example of a terminal 100 requesting screen sharing during a voice call according to one embodiment of the present disclosure.

The terminal 100 may establish a voice call with at least one other terminal 300 through an application 301. The screen of the application 301 may include a terminal status icon 303, chat room information 305, account information 311 of the terminal 100, and account information 313, 315, 317, 319, and 321 of at least one other terminal 300.

According to one embodiment, the terminal status icon 303 may be an icon indicating battery status information of the terminal 100, Wi-Fi (Wi-Fi connection status), network signal information, notification display information, current time information, etc. The chat room information 305 may be chat room information on the application and may include chat room name, chat room status, chat room link information, etc. For example, the chat room information 305 may include ‘Travel Club’, which is the name of a chat room in which the terminal 100 is currently participating, and ‘6 people’, which is information on the number of people participating in the chat room.

The account information 311 of the terminal 100 may be user profile information, chat name information, status message information, etc. of the terminal 100. For example, the account information 311 of the terminal 100 may include user profile information 311a and user chat name information 311b. Here, the user profile information 311a and the user chat name information 311b may be information used in all chat rooms of the application 301 or information used only in a specific chat room of the application 301. Additionally, the user profile information 311a and the user chat name information 311b may be entered and changed by the user of the terminal 100.

The account information 313, 315, 317, 319, and 321 of at least one other terminal 300 may include user profile information 313a, 315a, 317a, 319a, and 321a and user chat name information 313b, 315b, 317b, 319b, and 321b, respectively. Here, each of the account information 313, 315, 317, 319, and 321 of at least one other terminal 300, that is, the user profile information 313a, 315a, 317a, 319a, and 321a and the user chat name information 313b, 315b, 317b, 319b, and 321b, may be information used in all the chat rooms of the application 301 or information used only in a specific chat room of the application 301. In addition, the account information 313, 315, 317, 319, and 321 of at least one other terminal 300, that is, the user profile information 313a, 315a, 317a, 319a, and 321a and the user chat name information 313b, 315b, 317b, 319b, and 321b, may be entered and changed by another terminal for each account.

The terminal 100 may receive a selection interaction with a screen sharing interface 331 during a voice call with at least one other terminal 300. Here, the authority to share a screen during a voice call may be granted to an account that created a chat room of the application 301 or to a specific account granted the authority by the account that created the chat room.

In one embodiment, when an account participating in a voice call wishes to share a screen, the account may request screen sharing permission from an account with the authority to grant screen sharing. The account may perform screen sharing only if permission is granted by the account with the authority to grant screen sharing.

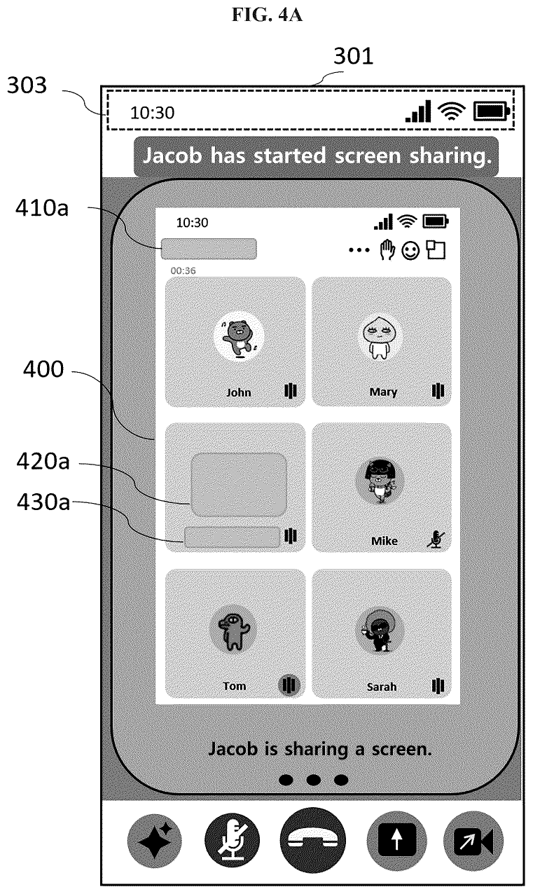

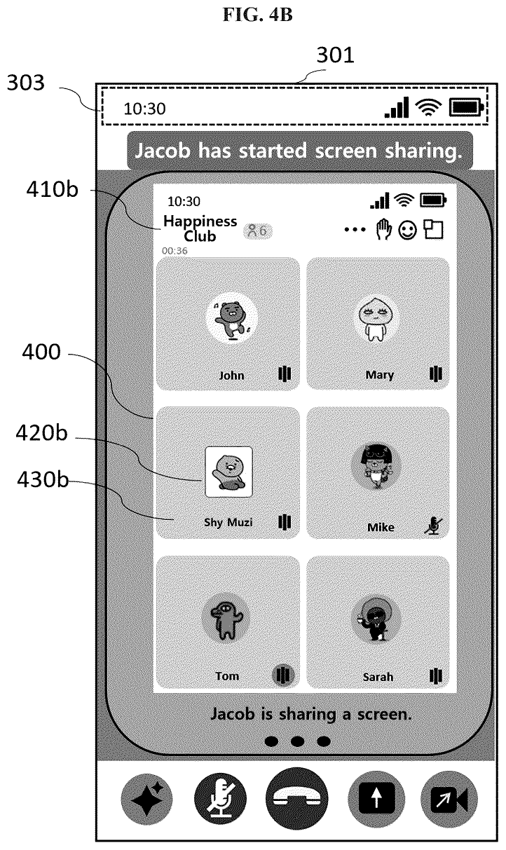

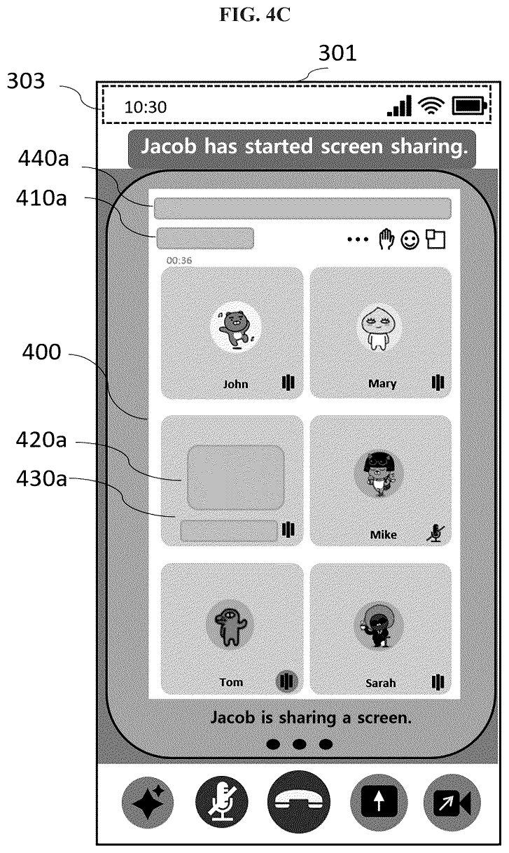

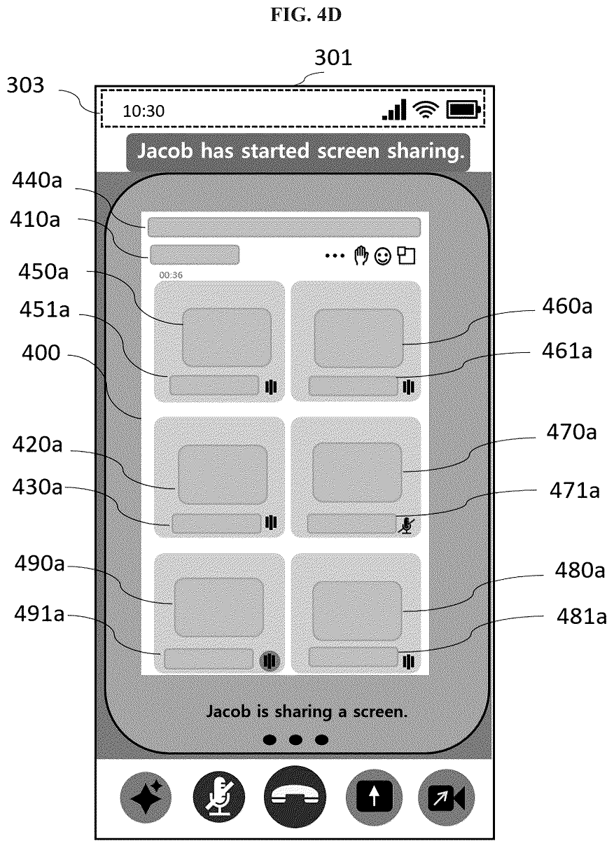

FIGS. 4A to 4D are drawings illustrating an example of the terminal 100 displaying a screen with certain information restricted during a voice call.

Referring to FIG. 4A, when the terminal 100 receives a selection interaction with the screen sharing interface 331, the terminal 100 may initiate screen sharing of one application of the terminal 100 with at least one other terminal 300. Here, a shared screen 400 of the terminal 100 may be a screen of an application currently running on the terminal 100 or a screen of an application selected by the terminal 100. The terminal 100 may share the shared screen 400 with at least one other terminal 300, where the chat room information 305, user profile information 311a, and user chat name information 311b are each blurred as indicated by reference numerals 410a, 420a, and 430a.

Referring to FIG. 4B, during screen sharing with at least one other terminal 300, the terminal 100 may share the shared screen 400 with at least one other terminal 300, where the chat room information 305, the user profile information 311a, and the user chat name information 311b are each changed to random information. For example, the chat room information 305 ‘Travel Club’ may be changed to random chat room information 410b ‘Happiness Club’, and the user chat name information 311b ‘Jacob’ may be changed to random chat name information 430b ‘Shy Muzi’. As an additional example, user profile information 311a may be changed to random profile information 420b. Here, random information (e.g., the random chat room information 410b, the random image information 420b, the random chat name information 430b), to which the chat room information 305, the user profile information 311a, and the user chat name information 311b are changed, may be information randomly selected by the terminal 100 or the server 200.

According to yet another embodiment, random information (e.g., the random chat room information 410b, the random image information 420b, the random chat name information 430b), to which the chat room information 305, the user profile information 311a, and the user chat name information 311b are changed, may be information preset by the terminal 100 or server 200 to be displayed during screen sharing. The terminal 100 or server 200 may preset different chat room information, user profile information, and user chat name information for each chat room. For example, the terminal 100 may set a related feature to apply and share first chat room information (e.g., a first chat room name) and first chat name information when sharing a screen in a first chat room. In addition, the terminal 100 may set a related feature to apply and share second chat room information (e.g., a second chat room name different from the first chat room name) and second chat name information different from the first chat name information when sharing a screen in a second chat room.

Referring to FIG. 4C, when the terminal 100 shares a screen with at least one other terminal 300, a terminal status icon 303 indicating battery status information of the terminal 100, Wi-Fi (Wi-Fi connection status), network signal information, notification display information, current time information, etc., may be blurred as indicated by reference numeral 440a. The terminal 100 may share the shared screen 400, which is blurred as indicated by reference numeral 440a, with at least one other terminal 300.

According to one embodiment, the terminal 100 may blur an icon indicating push notification information during screen sharing with at least one other terminal 300. For example, when the terminal 100 receives a chat message, a text message, or the like during screen sharing, the terminal 100 may blur push notification information (e.g., a pop-up message, etc.) displayed in real time on the terminal 100.

Referring to FIG. 4D, the terminal 100 may share the shared screen 400 with at least one other terminal 300, where user profile information 313a, 315a, 317a, 319a, and 321a and user chat name information 313b, 315b, 317b, 319b, and 321b of at least one other terminal 300 are blurred as indicated by reference numerals 450a, 451a, 460a, 461a, 470a, 471a, 480a, 481a, 490a, and 491b.

According to one embodiment, the terminal 100 may blur only user profile information and user chat name information of some accounts among all accounts of at least one other terminal 300 which has established a call connection with the terminal. For example, only the user profile information 313a and the user chat name information 313b of at least one other terminal 300 may be blurred as indicated by reference numerals 450a and 451a, while the user profile information 315a, 317a, 319a, and 321a and the chat name information 315b, 317b, 319b, and 321b of at least one other terminal 300 may not be blurred.

According to one embodiment, the terminal 100 may request related information from the server 200 to check whether the account information 313, 315, 317, 319, and 321 of at least one other terminal 300 is blurred. For example, the terminal 100 and at least one other terminal 300 may preset whether to blur account information during screen sharing. In the above example, the terminal 100 may determine whether to blur the account information 313, 315, 317, 319, and 321 of at least one other terminal 300, based on a setting made by at least one other terminal 300 on whether to blur account information.

According to another embodiment, the terminal 100 and/or the server 200 may check whether each of the account information 313, 315, 317, 319, and 321 of at least one other terminal 300 is a single profile or multi-profile. Here, the multi-profile may refer to a profile that allows one account to create, change, and utilize multiple different user profiles within an application. For example, when the terminal 100 and/or the server 200 determine that the terminal 100 operates a multi-profile with account information 313 of another terminal, the account information 313 of the other terminal may not be de-identified.

According to yet another embodiment, the terminal 100 may not de-identify the chat room information 305, the user profile information 311a, and the user chat name information 311b, but may de-identify only the user profile information 313a, 315a, 317a, 319a, and 321a and the user chat name information 313b, 315b, 317b, 319b, and 321b of at least one other terminal 300.

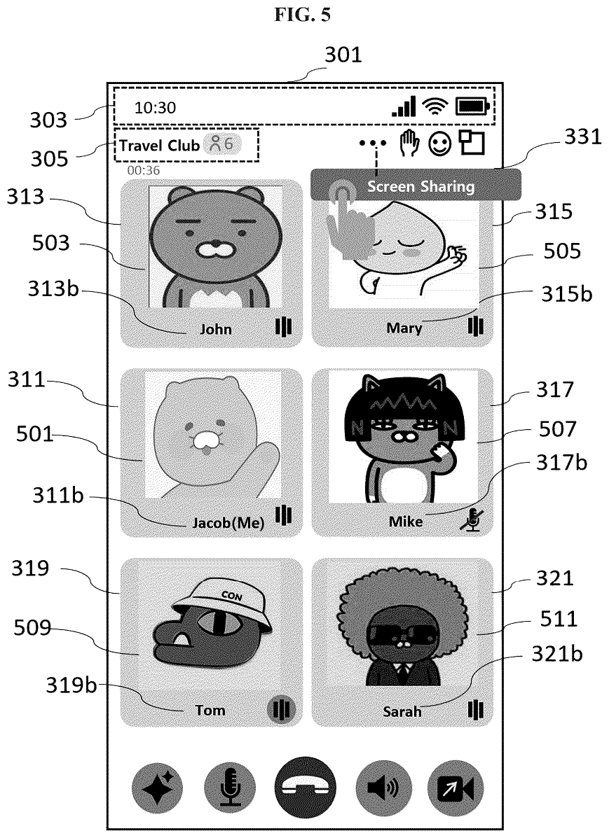

FIG. 5 is a diagram illustrating an example of a terminal 100 requesting screen sharing during a video call according to one embodiment of the present disclosure.

The terminal 100 may establish a video call with at least one other terminal 300 through an application 301. A screen of the application 301 may include a video screen 501 captured by a camera module of the terminal 100 and video screens 503, 505, 507, 509, and 511 captured by each camera module of another terminal. In FIG. 5, for convenience of explanation, video screens 501, 503, 505, 507, 509, and 511 captured by a camera module are represented as graphic images, may be actual images captured by a camera module of each terminal (e.g., a user's face, a user's background screen through a camera module, etc.).

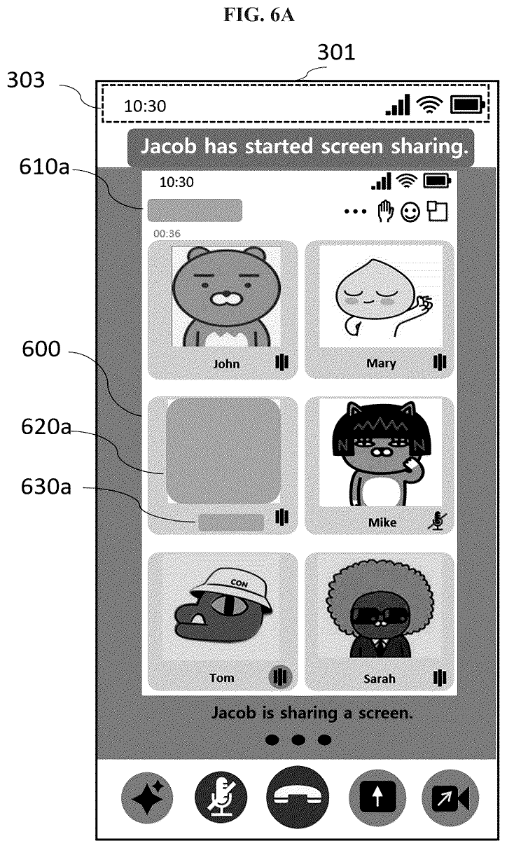

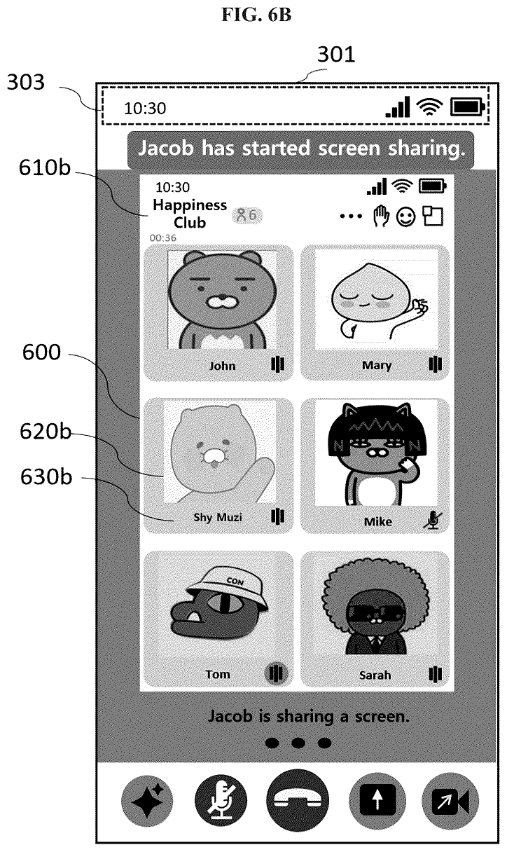

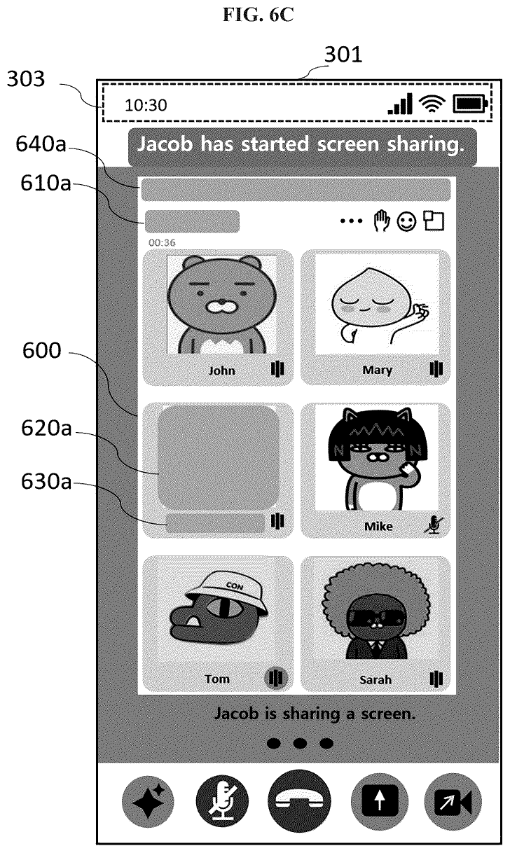

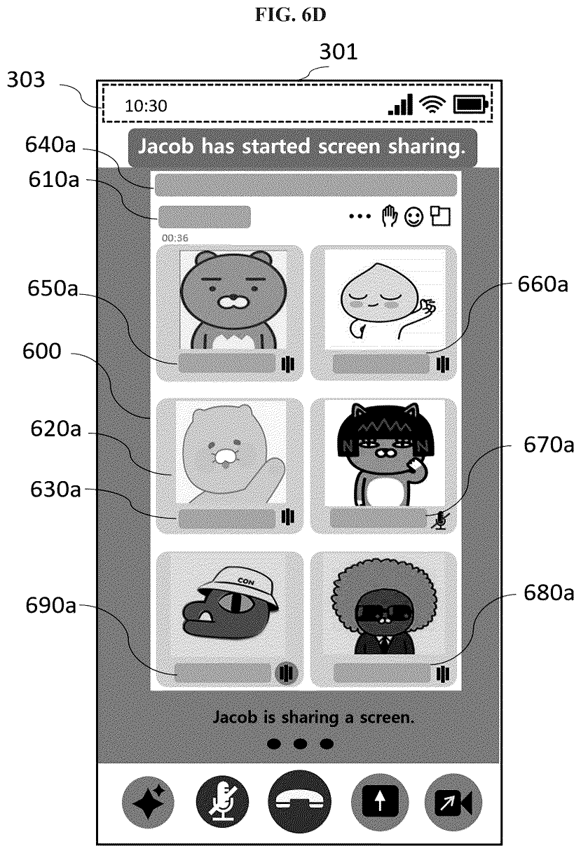

FIGS. 6A to 6D are drawings illustrating an example of a terminal 100 displaying a screen with certain information restricted during a video call.

Referring to FIG. 6A, when the terminal 100 receives a selection interaction with a screen sharing interface 331, the terminal 100 may initiate screen sharing of one application of the terminal 100 with at least one other terminal 300. Here, a shared screen 600 of the terminal 100 may be a screen of an application currently running on the terminal 100 or a screen of an application selected by the terminal 100. The terminal 100 may share the shared screen 600 with at least one other terminal 300, where chat room information 305, a video screen 501 of the terminal 100 and user chat name information 311b are each blurred as indicated by reference numerals 610a, 620a, and 630a.

Referring to FIG. 6B, during screen sharing with at least one other terminal 300, the terminal 100 may share the shared screen 600 with at least one other terminal 300, where the chat room information 305 and the user chat name information 311b are each changed to random information. For example, the chat room information 305 ‘Travel Group’ may be changed to random chat room information 610b ‘Happiness Club’, and the user chat name information 311b ‘Jacob’ may be changed to random chat name information 630b ‘Shy Muzi’. As an additional example, the video screen 501 of the terminal 100 may be changed to random image information 620b. Here, random information (e.g., the random chat room information 610b, the random image information 620b, and the random chat name information 630b) to which the chat room information 305, the video screen 501 of the terminal 100, and the user chat name information 311b are changed may be information randomly selected by the terminal 100 or the server 200.

According to yet another embodiment, random information (e.g., the random chat room information 610b, the random image information 620b, the random chat name information 630b) to which the video screen 501 of the terminal 100 is changed may be information preset by the terminal 100 or the server 200 to be displayed during screen sharing. The terminal 100 or server 200 may preset different image information for each chat room. For example, the terminal 100 may set a related feature to apply and share the first image when sharing a screen in the first chat room. In addition, the terminal 100 may set a related feature to apply and share second image information different from the first image information when sharing a screen in a second chat room.

Referring to FIG. 6C, when the terminal 100 shares a screen with at least one other terminal 300, a terminal status icon 303 indicating battery status information of the terminal 100, Wi-Fi (Wi-Fi connection status), network signal information, notification display information, current time information, etc., may be blurred as indicated by reference numeral 640a. The terminal 100 may share the shared screen 600, blurred as indicated by reference numeral 640a, with at least one other terminal 300.

Referring to FIG. 6D, the terminal 100 may share a shared screen 600 with at least one other terminal 300, where user chat name information 313b, 315b, 317b, 319b, and 321b in the account information 313, 315, 317, 319, and 321 of the at least one other terminal 300 is blurred as indicated by reference numerals 650a, 660a, 670a, 680a, and 690a.

According to one embodiment, the terminal 100 may blur the user chat name information of some accounts among all accounts of at least one other terminal 300 that has established a call connection with the terminal 100, while changing user chat name information of other accounts to random information. For example, the user chat name information 313b and 315b of at least one other terminal 300 may be blurred as indicated by reference numeral 650a and 660a, while the other user chat name information 317b, 319b, and 321b may be changed to random information and shared.

According to one embodiment, the terminal 100 may request related information from the server 200 to check whether the account information 313, 315, 317, 319, and 321 of at least one other terminal 300 is blurred. For example, the terminal 100 and at least one other terminal 300 may preset whether to blur account information during screen sharing. In the above example, the terminal 100 may determine whether to blur the account information 313, 315, 317, 319, and 321 of at least one other terminal 300, based on a setting made by at least one other terminal 300 on whether to blur account information.

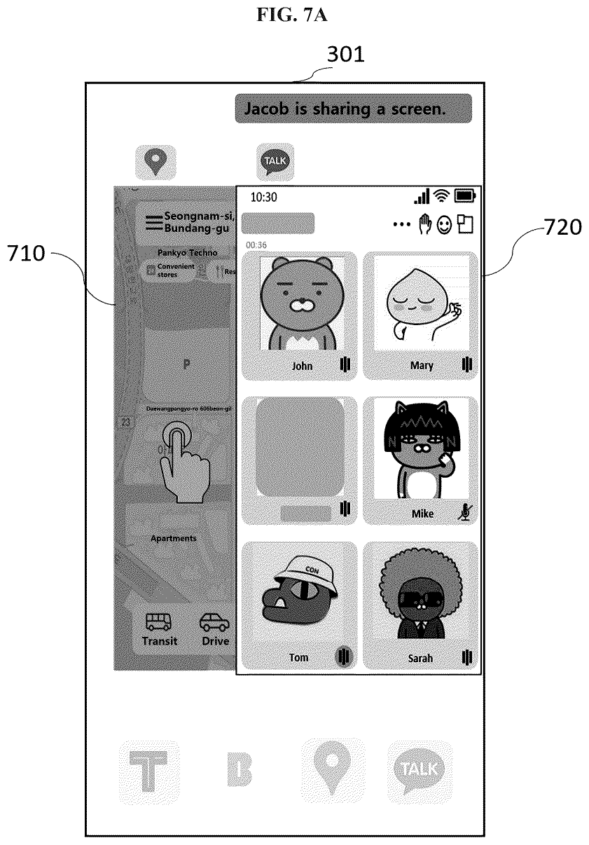

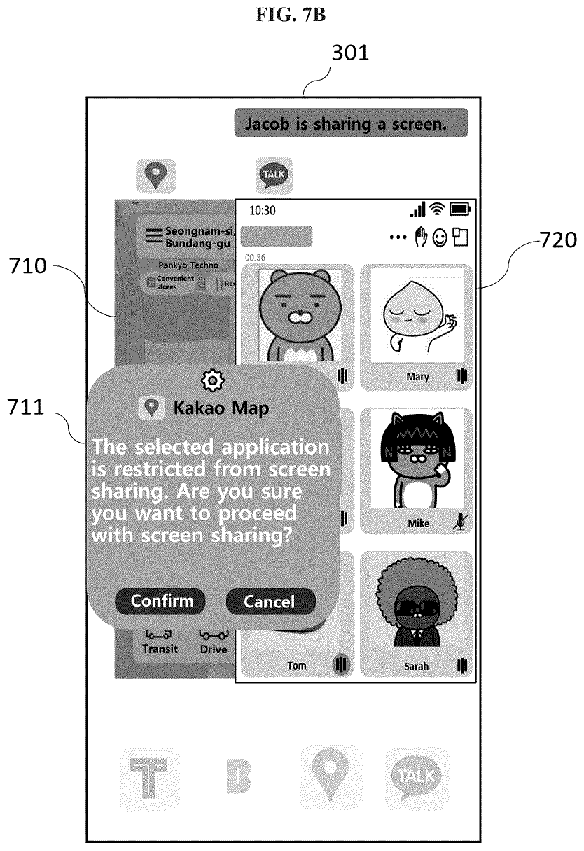

FIG. 7A and FIG. 7B are diagrams illustrating examples in which a terminal 100 selects a screen sharing-restricted application.

According to various embodiments, the terminal 100 may select an application for screen sharing with at least one other terminal 300. For example, for screen sharing, the terminal 100 may receive a selection interaction with one of a map application 710 and a messenger application 720.

Referring to FIG. 7A, the terminal 100 may receive an interaction selecting the map application 710 for screen sharing. Referring to FIG. 7B, the terminal 100 may determine whether the application that has received the interaction is a preset screen sharing-restricted application. For example, if the map application 710 is set as an application in which sharing with other terminals is not allowed, the terminal 100 may display a screen sharing restriction pop-up message 711 on the screen. In the above example, when the terminal 100 receives an interaction with ‘Confirm’ displayed in the screen sharing restriction pop-up message 711, the map application 710 may initiate screen sharing with another terminal.

According to yet another embodiment, sharing restriction of a specific application may be set by the server 200, regardless of selection by the user of the terminal 100. For example, the server 200 may set banking applications, stock trading applications, copyright-protected applications, test evaluation applications, and the like as applications in which sharing with other terminals are not allowed. In the above example, if the application selected for screen sharing is a preset screen sharing-restricted application, the terminal 100 may restrict screen sharing with other terminals. Additionally, the terminal 100 may display, on a screen of the terminal 100, a pop-up message indicating a screen sharing-restricted application.

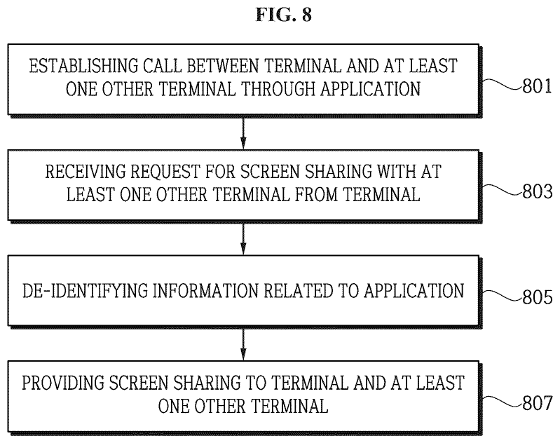

FIG. 8 is a diagram illustrating an example of a server 200 that provides screen sharing with certain information restricted between a terminal 100 and at least one other terminal 300.

Referring to operation 801, the server 200 may establish a call between the terminal 100 and at least one other terminal 300 through an application. Referring to operation 803, the server 200 may receive a screen sharing request from the terminal 100 to share a screen with at least one terminal.

Referring to operation 805, the server 200 may de-identify information related to the application. For example, the server 200 may de-identify at least one of chat room information on the application and account information on the terminal 100.

For example, the server 200 may blur at least one of the chat room information on the application and the account information on the terminal 100 so that the blurred information is not shared between the terminal 100 and at least one other terminal 300. As another example, the server 200 may change at least one of the chat room information on the application and the account information on the terminal 100 to random information. As an additional example, the server 200 may de-identify (e.g., blurring or changing to random information) account information on at least one other terminal 300 which has established a call with the terminal 100. According to yet another embodiment, the server 200 may receive an interaction of the terminal 100 with a screen sharing interface that supports the terminal 100 executing screen sharing. The server 200 may blur at least one of the chat room information on the application and the account information on the terminal 100 so that the blurred information is not shared between the terminal 100 and at least one other terminal 300.

Referring to operation 807, the server 200 may provide screen sharing to the terminal 100 and at least one other terminal 300. The server 200 may provide the terminal 100 and at least one other terminal 300 with screen sharing in which certain information (e.g., chat room name information, profile information of a user of the terminal 100) is restricted.

According to various embodiments, the server 200 may determine whether an application selected by the terminal 100 for screen sharing is a preset screen sharing-restricted application. For example, the server 200 may set banking applications, stock trading applications, copyright-protected applications, test evaluation applications, and the like as applications in which sharing with other terminals are not allowed. In the above example, if the application selected by the terminal 100 for screen sharing is a preset screen sharing-restricted application, the server 200 may restrict screen sharing with at least one other terminal 300.

The present disclosure may provide various technical effects and innovations. For example, by limiting the sharing of information related to an application (e.g., at least one of chat room information on the application and account information on a terminal), it is possible to minimize unnecessary exposure of personal information of terminal users and strengthen the terminal user's control.

In addition, by applying data masking technology to blur a part of a screen shared between terminals, it is possible to protect the privacy of terminal users and build reliability.

At least part of the devices (e.g., modules or functions thereof) or methods (e.g., operations) according to various embodiments may be implemented with instructions as programming modules that are stored in computer-readable storage media. In one embodiment, an instruction, when executed by a processor (e.g., the processor 110, the processor 210, the processor 310, etc.), may cause one or more processors to perform functions corresponding to the instruction. The computer-readable storage medium may be, for example, a memory (e.g., the memory 150, the memory 220, and the memory 350).

Examples of computer-readable media include: magnetic media, such as hard disks, floppy disks, and magnetic tape; optical media such as Compact Disc Read Only Memory (CD-ROM) disks and Digital Versatile Disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

The technical features disclosed in each embodiment of the present disclosure are not limited to a corresponding embodiment, and unless incompatible with each other, the technical features disclosed in each embodiment may be applied in combination to other embodiments. It will be further understood by those within the art that any disjunctive word and/or phrase presenting two or more alternative terms, whether in the description, claims, or drawings, can be understood to contemplate the possibilities of including one of the terms, at least one of the terms, or both terms. For example, the phrase “A or B” will be understood to include the possibilities of “A” or “B” or “A and B.” Further, the term “each,” as used herein, in addition to having its ordinary meaning, can mean any subset of a set of elements to which the term “each” is applied. Conjunctive expressions such as the phrase “at least one of X, Y, and Z,” unless specifically stated otherwise, is understood with the context as used in general to convey that an item, term, etc. may be either X, Y, or Z. Thus, such conjunctive expressions are not generally intended to imply that certain embodiments require the presence of at least one of X, at least one of Y, and at least one of Z.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be defined by the equivalents of claims of the present disclosure as well as the claims.

What is claimed is:

1. A method for providing screen sharing by a terminal during a call, the method comprising:
establishing a call with at least one other terminal through an application;
receiving an interaction requesting screen sharing with the at least one other terminal;
de-identifying information related to the application; and
initiating screen sharing with the at least one other terminal.

2. The method of claim 1, wherein the information related to the application comprises at least one of chat room information on the application or account information on the terminal.

3. The method of claim 1, wherein the de-identifying comprises blurring at least one of the chat room information on the application or the account information on the terminal to prevent sharing with the at least one other terminal.

4. The method of claim 1, wherein the de-identifying comprises changing at least one of the chat room information on the application or the account information on the terminal.

5. The method of claim 1, further comprising deactivating a camera module of the terminal in response to receiving an interaction requesting screen sharing with the at least one other terminal.

6. The method of claim 1, further comprising de-identifying the account information on the at least one other terminal that has established the call.

7. The method of claim 1, further comprising, in response to an interaction requesting screen sharing with the at least one other terminal, de-identifying at least one a status icon, a notification display information icon, or a control icon of the terminal.

8. The method of claim 1, wherein the de-identifying comprises:
when screen sharing with the at least one other terminal is initiated, displaying on a screen of the terminal a screen sharing interface that supports execution of the screen sharing; and
in response to an interaction with a de-identification interface included in the screen sharing interface, de-identifying at least one of the chat room information on the application or the account information on the terminal to prevent sharing with the at least one other terminal.

9. The method of claim 1, further comprising:
receiving a selection interaction with an application for screen sharing with the at least one other terminal; and
determining whether the application that has received the selection interaction is a preset screen sharing-restricted application.

10. The method of claim 1, further comprising:
receiving a selection interaction with an application for screen sharing with at least one other terminal;
initiating screen sharing of an application that has received the selection interaction, with at least one other terminal; and
when the application is in a background state due to the interaction of the terminal, terminating the initiated screen sharing.

11. A terminal providing screen sharing during a call, the terminal comprising:
a memory storing instructions; and
a processor configured to execute the instructions to:
establish a call with at least one other terminal through an application;
receive an interaction requesting screen sharing with the at least one other terminal;
de-identify information related to the application; and
initiate screen sharing with the at least one other terminal.

12. A method for providing screen sharing by a server during a call, the method comprising:
establishing a call between a terminal and at least one other terminal through an application;
receiving a screen sharing request from the terminal to share a screen with the at least one other terminal;
de-identifying information related to the application; and
providing screen sharing to the terminal and the at least one other terminal.

13. The method of claim 12, wherein the information related to the application comprises at least one of chat room information on the application or account information on the terminal.

14. The method of claim 12, wherein the de-identifying comprises blurring at least one of chat room information on the application or account information on the terminal to prevent sharing between the terminal and the at least one other terminal.

15. The method of claim 12, wherein the de-identifying comprises changing at least one of the chat room information on the application or the account information on the terminal.

16. The method of claim 12, further comprising de-identifying the account information on the at least one other terminal having established the call with the terminal.

17. The method of claim 16, wherein de-identifying the account information on the at least one other terminal having established the call with the terminal comprises changing the account information on the at least one other terminal.

18. The method of claim 12, wherein the de-identifying comprises:
receiving an interaction of the terminal with a screen sharing interface that supports execution of screen sharing of the terminal; and
de-identifying at least one of the chat room information on the application and the account information on the terminal so that the blurred information is not shared between the terminal and the at least one other terminal.
